(19) United States
(12) Patent Application Publication
(10) Pub. No.: US 2012/0298282 A1
(43) Pub. Date: Nov. 29, 2012

(54) LAMINATING A COMPONENT

(76) Inventor: Michael Greidenweis, Spaichingen (DE)

(21) Appl. No.: 13/477,443

(22) Filed: May 22, 2012

(30) Foreign Application Priority Data
May 24, 2011 (DE) 10 2011 102 998.6

(51) Int. Cl. B32B 37/10; B32B 37/12

(52) U.S. Cl. 156/60; 156/580

(57) ABSTRACT

A method and a device are provided for laminating a component, in particular an interior lining component for a motor vehicle, which is arranged on a lower die of a press tool and which is overlaid with a pre-fixed laminating material. The laminating material is fixed on the surface of the component by means of a seam fixing stay which is formed as an integral constituent part of the upper die of the press tool.

The present invention relates to a method for laminating a component, in particular an interior lining component for a motor vehicle, which is arranged on a lower die of a press tool and which is overlaid with a pre-fixed laminating material, as per the features of the preamble of claim 1, and to a device for laminating a component as per the features of the preamble of claim 4. Interior lining components for motor vehicles are nowadays generally produced from plastic and often have a multi-layered structure composed of at least one support component and one surface layer. These are generally injection-molded plastic components in which molded skins, fabrics, textile materials, leather or artificial leather are used as a surface layer or decorative layer. Nowadays, too, in particular in the case of sensitive materials, use is still made of the so-called laminating technique in which the component is produced in a separate working process before subsequently being laminated with the laminating material, wherein the laminating material is fixedly connected to the component surface.

Laminating processes of said type are described for example in WO 2005/037586 A1, in DE 2 925 500 A1 and in DE 10 2005 042 819 A1.

In general, the laminating tools are press tools which are composed of an upper die and a lower die, wherein during the laminating process the component to be laminated lies in a form-fitting manner on the lower die and the laminating material is pressed onto the component surface by means of the upper die which is likewise adapted to the shape of the component. The connection between the component surface and the laminating material is realized by the activation and formation of an adhesive intermediate layer.

A disadvantage of the known methods is that, in the case of components of complex shape, the alignment of the laminating material is often associated with problems, and displacements of the laminating material may occur during the bringing-together of the lower die and upper die, which leads to significant problems in particular in the case of interior lining components for motor vehicles, where flawless appearance plays a very important role.

It is therefore an object of the present invention to specify a method and a device by means of which the abovementioned problems can be eliminated. The object is achieved by means of a method having the features of claim 1 and by means of a device having the features of claim 4.

The corresponding subclaims relate to advantageous embodiments and refinements of the method and of the device.

The method according to the invention is based on the use of suitable measures during the laminating process for preventing displacement or slipping of the laminating material on the component surface.

This is achieved by means of a method for laminating a component, in particular an interior lining component for a motor vehicle, which is arranged on a lower die of a press tool and which is overlaid with a pre-fixed laminating material, in which method, in a first step, the laminating material is fixed on the surface of the component by means of a seam fixing stay when the press tool is open. The lower die is subsequently transferred together with the component and the seam fixing stay placed thereon into a heating furnace, where the adhesive layer provided between the component surface and laminating material is activated.

After the activation of the adhesive layer, the lower die is removed from the laminating furnace and the press tool is closed by bringing the upper die and lower die together. What is essential here is that the seam fixing stay is formed as an integral constituent part of the upper die and, during the bringing-together of the upper die and lower die, remains in its fixing position on the component which is overlaid with the laminating material. In this way, it is made possible for the upper die to have a receptacle for the seam fixing stay, into which receptacle said seam fixing stay is inserted during the closing of the press tool. In this way, it is ensured that the laminating material remains fixed during the bringing-together of the two die parts, and slipping of the laminating material cannot occur.

After the closing of the press tool, the formation of the connection between the component and laminating material is completed by the exertion of pressure on the component surface by the upper die. In said method step, the press tool is advantageously cooled, whereby the final fixing of the laminating material to the component surface can be accelerated.

The method described above is suitable for laminating materials which have a seam or are seamless and which are selected from the group comprising leather, plastic foil, fabric, textile materials and artificial leather.

The present invention also relates to a device for laminating a component, in particular an interior lining component for a motor vehicle, which is overlaid with a pre-fixed laminating material, wherein the device comprises a laminating press, a press tool and a laminating or heating furnace. The press tool is composed of an upper die and a lower die, wherein the lower die is provided as a primary component receptacle, whereas the upper die, which has a seam fixing stay as an integral constituent part and comprises corresponding receptacles for the insertion of the seam fixing stay, is provided for exerting pressure on the component surface.

The present invention will be explained in detail below on the basis of an exemplary embodiment and the corresponding drawings, in which:

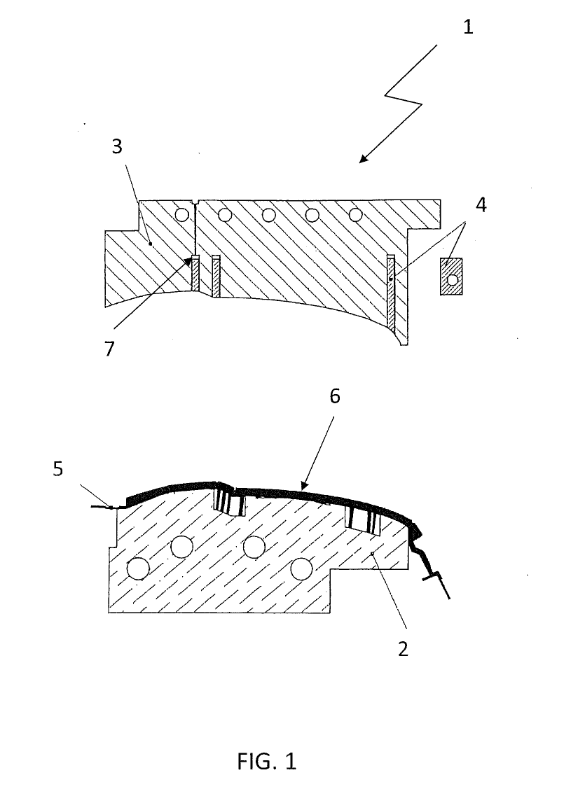

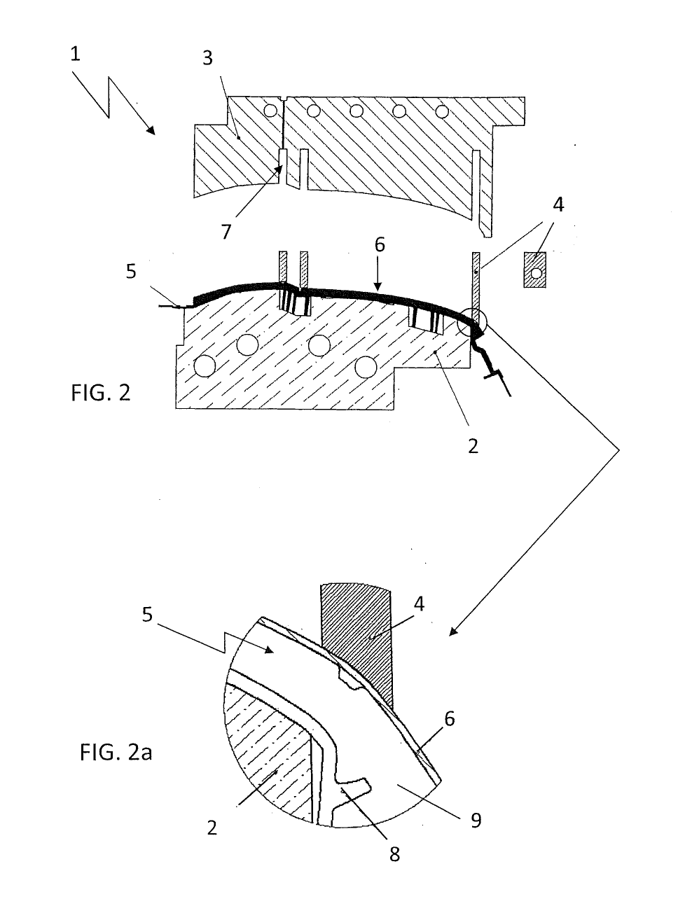

FIGS. 1 and 2 show, in the same sectional illustration in each case, a detail of the press tool according to the invention at different times during the method;

FIG. 2a shows an enlarged detail from FIG. 2;

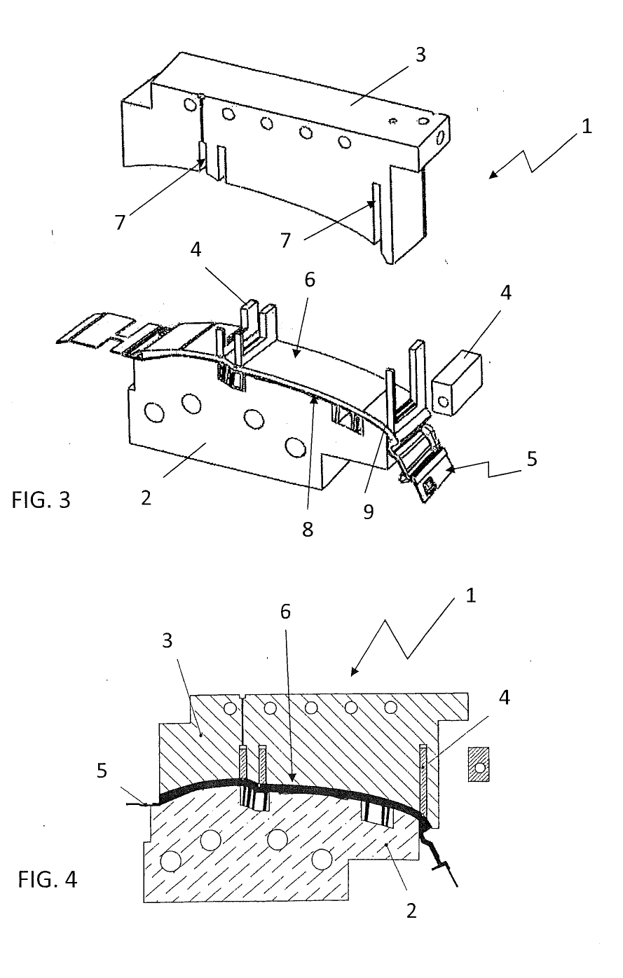

FIG. 3 shows a detail of the press tool according to the invention in a perspective view; and

FIG. 4 shows a further sectional illustration of the detail from FIGS. 1 and 2.

Before a detailed explanation of the figures is given, it should be noted that the selected drawings are sketch-like, relatively small details of a press tool according to the invention, which details serve and have also been purposely selected to depict and illustrate the principle of the invention. To a person skilled in the art, it is self-evident that the entire laminating device, which comprises a laminating press, a laminating tool with an upper die, a lower die and a seam fixing stay and also a laminating furnace, wherein each of the partial regions of the device mentioned above has its own mechanical engineering peripherals, is significantly more complex than is apparent from the selected drawings.

FIG. 1 shows the open press tool 1 with the upper die 3 and the lower die 2, wherein the component 5 overlaid with a pre-fixed laminating material 6 is already arranged on the lower die 2, whereas the fixing stay 4, still in its initial position, is integrated into the receptacles 7 in the upper die 3.

FIG. 2 shows, likewise in a sectional illustration, a detail of the laminating tool in the open state, wherein the fixing stay 4 is now resting on the laminating material 6 and thus fixes the laminating material 6 and prevents slipping of the laminating material 6.

In this situation, the lower die 2 together with the component 5 and seam fixing stay 4 is transferred into the laminating furnace, where the activation of the adhesive takes place. Said method step is however not depicted in the drawings.

Different adhesives may be used for said step. In one advantageous embodiment of the present invention, use is made for this purpose of heat-activatable adhesives, so-called hot melts, and the temperatures in the laminating furnace are selected such that the adhesive is fully activated and the component can form a firm connection with the laminating material.

FIG. 2a shows an enlarged detail from FIG. 2. Said enlarged detail has been selected to illustrate the design of the component 5 constructed from a support 8, from an intermediate layer 9 and from the laminating material 6 provided as a decorative layer. The component 5 rests on the lower die 2, wherein the laminating material 6 is fixed by means of the seam fixing stay 4.

FIG. 3 shows a perspective plan view of the detail from FIG. 2. The press tool 1 is still open, while the seam fixing stay 4 is already lying on the laminating material 6 and is fixing said laminating material to the component 5, which in turn is resting on the lower die 2. The selected illustration also shows the layered structure of the component 5 with the support 8 and intermediate layer 9.

FIG. 4 shows the final method step, after the lower die 2 has been returned from the laminating furnace into the laminating press and the upper die 3 and the lower die 2 have been brought together, such that the component 5 which is overlaid with the laminating material 6 is enclosed between the two dies. Here, the final fixing of the laminating material 6 to the component surface takes place under pressure.

### LIST OF REFERENCE NUMERALS

1 Press tool

2 Lower die

3 Upper die

4 Seam fixing stay

5 Component

6 Laminating material

7 Receptacle

8 Support

9 Intermediate layer

1. A method for laminating a component, which is arranged on a lower die of a press tool combined with a laminating press and which is overlaid with a pre-fixed laminating material, the method comprising:
fixing the laminating material on a surface of the component using a seam fixing stay when the press tool is open;
transferring the lower die with the component and the seam fixing stay into a laminating furnace;
activating an adhesive layer provided between the laminating material and the component;
returning the lower die with the component and the seam fixing stay into the laminating press;
closing the press tool by placing an upper die onto the lower die and bringing the upper die and lower die together; and
forming a firmly adherent connection between the laminating material and the surface of the component, wherein the seam fixing stay is formed as an integral constituent part of the upper die and, during the bringing-together of the upper die and the lower die, the seam fixing stay remains on the component which is overlaid with the laminating material, wherein the upper die has a receptacle for the seam fixing stay, and wherein the seam fixing stay is inserted into the receptacle during the closing of the press tool.

2. The method according to claim 1, wherein the laminating material has a seam or is seamless and is at least one of: leather, plastic foil, fabric, textile or artificial leather.

3. The method according to claim 1, wherein the activating of the adhesive layer provided between the laminating material and the surface of the component takes place in the form of a thermal activation of a heat-activatable adhesive.

4. A device for laminating a component, which is overlaid with a pre-fixed laminating material, the device comprising:
a press tool combined with a laminating furnace and a laminating press, wherein the press tool comprises includes an upper die and a lower die, wherein the lower die is provided as a receptacle for the component, and wherein the upper die has a seam fixing stay as an integral constituent part and includes a receptacle for insertion of the seam fixing stay.

5. The device according to claim 4, wherein the component is an interior lining component for a motor vehicle.

6. The method according to claim 1, wherein the component is an interior lining component for a motor vehicle.

7. A method for laminating a component which is arranged on a lower die of a press tool, the method comprising:
fixing a laminating material on a surface of the component using a seam fixing stay when the press tool is open;
transferring the lower die with the component and the seam fixing stay into a laminating furnace;
activating an adhesive layer provided between the laminating material and the component;
returning the lower die with the component and the seam fixing stay into a laminating press;
closing the press tool by placing an upper die onto the lower die and bringing the upper die and lower die together; and
forming an adherent connection between the laminating material and the surface of the component, wherein, during the bringing-together of the upper die and the lower die, the seam fixing stay remains on the component, wherein the upper die has a receptacle for the seam fixing stay, and wherein the seam fixing stay is inserted into the receptacle during the closing of the press tool.

8. The method according to claim 7, wherein the laminating material has a seam.

9. The method according to claim 7, wherein the laminating material is seamless.

10. The method according to claim 7, wherein the laminating material is at least one of:
leather, plastic foil, fabric, textile or artificial leather.

11. The method according to claim 7, wherein the activating of the adhesive layer provided between the laminating material and the surface of the component includes thermal activation of a heat-activatable adhesive.

12. The method according to claim 7, wherein the component is an interior lining component for a motor vehicle.
